(19) United States
(12) Patent Application Publication
(10) Pub. No.: US 2025/0307659 A1
(43) Pub. Date: Oct. 2, 2025

(54) SYSTEM AND METHOD FOR PREDICTING DIVERSE FUTURE GEOMETRIES WITH DIFFUSION MODELS

(71) Applicant: Robert Bosch GmbH, Stuttgart (DE)

(72) Inventors: Jiajing GUO, Mountain View, CA (US); Vikram MOHANTY, Arlington, VA (US); Hongtao HAO, Madison, WI (US); Jorge Henrique PIAZENTIN ONO, Sunnyvale, CA (US); Liang GOU, San Jose, CA (US); Liu REN, Saratoga, CA (US)

(21) Appl. No.: 18/624,810

(22) Filed: Apr. 2, 2024

(51) Int. Cl. G06N 5/01; G06F 16/953

(52) U.S. Cl. CPC G06N 5/01; G06F 16/953

(57) ABSTRACT

A method of generating data that includes receiving a data indicating a query associated with a task representative of a domain, wherein the task includes generated executable software code, receiving data indicating one or more descriptions associated with the domain, receiving one or more exemplars associated with the data indicating the query response to an exemplar search engine running a search utilizing the data indicating the query, utilizing the exemplars and the data indicating descriptions to generate results including executable software code, wherein the results are generated utilizing a data profiler, a prompt manager utilizing the data indicating one or more descriptions associated with the domain, and an executor configured to execute the executable software code, outputting results associated with the executable software code, wherein the results includes one or more confidence scores, and in response to a selection-input, saving the one or more results in the database.

### TECHNICAL FIELD

The present disclosure relates to machine learning networks, including those that utilize a large language model.

### BACKGROUND

Domain-specific data operations include various activities such as data transformation, processing, and analysis within specialized domains, such as medicine, manufacturing, finance, sports, and more. Conducting complex data operations may require a profound understanding of the specific data structures, as well as comprehensive knowledge of the unique concepts and terminologies relevant to each domain.

In recent years, pre-trained Large Language Models (LLM) have shown strong capabilities in a variety of data science and machine learning tasks, such as visualization, junior-level data analysis, classification, and model selection. Many research communities and companies started to investigate Human-LLM collaboration as the future or programming, as studies showed that LLM can save developers' searching efforts, improve productivity and developer happiness.

Despite demonstrating robust capabilities in general-domain data operation tasks, LLMs may exhibit shortcomings when applied to domain-specific tasks. While the extensive training data enables LLMs to grasp a variety of concepts or terms, it may still be insufficient to understand meanings specific to certain organizations or nuanced contexts. For example, in manufacturing domains, “cycle time” generally refers to the time from the start to the finish of a process. It appears that many LLMs are aware of this general concept. However, depending on the design of manufacturing procedures, the calculation of cycle time can be more complicated. Some production lines do not have sensors to accurately capture the start and end of a process, while some lines may deviate parallel lines in the middle of production. The absence of such-domain specific knowledge may lead LLMs to produce wrong data operations and analysis. This may emphasize the importance of custom—tailored solutions when deploying LLMs in a specialized field.

A common practice among developers is to include domain-specific definitions every time they prompt LLMs to generate code. However, this method can be both time-consuming and repetitive, as it requires constant management of the prompts. Furthermore, it may not guarantee the quality of the code produced, since LLMs do not have the memory that enables them to retain the concepts that they have been previously taught.

A substantial body of empirical research has demonstrated that LLM can attain better performance when being prompted with a few exemplars representative of the target task. This may be understood as a few-shot prompt in or in-context learning. When asked a question relevant to a domain-specific concept, if LLMs are shown a few exemplars of the implementation code, LLMs are supposed to generate better responses, compared to the situation in which no exemplars are available. However, applying the few-shot prompting technique to domain-specific data analytics has many challenges that are unsolved. For example, it may be challenging to determine how the exemplars may be generated efficiently. Manual generation by data scientists is one solution, however it requires tremendous effort as domain concepts can be endless. Second, despite data scientists leveraging LLMs' power to generate exemplars, it may be challenging to minimize their effort to do prompt engineering and iterate the code.

### SUMMARY

A first embodiment discloses a method of generating data for machine learning (ML) models that includes receiving a data indicating a query associated with a task representative of a domain, wherein the task includes generated executable software code, receiving data indicating one or more descriptions associated with the domain, receiving one or more exemplars associated with the data indicating the query response to an exemplar search engine running a search utilizing the data indicating the query, utilizing both the one or more exemplars and the data indicating one or more descriptions associated with the domain at a large language model (LLM) to generate a plurality of results including executable software code, wherein the plurality of results is generated further utilizing a data profiler, a prompt manager utilizing the data indicating one or more descriptions associated with the domain, and an executor configured to execute the executable software code, outputting a plurality of results associated with the executable software code, wherein the plurality of results includes one or more confidence scores associated with the plurality of results, and in response to a selection-input, saving the one or more results in the database.

A second embodiment discloses a system that includes a processor programmed to receive a data indicating a query associated with a task representative of a domain, wherein the task includes generated executable software code, receive data indicating one or more descriptions associated with the domain, receive one or more exemplars associated with the data indicating the query in response to an exemplar search engine running a search utilizing the data indicating the query, utilizing both the one or more exemplars and the data indicating one or more descriptions associated with the domain at a large language model (LLM) to generate a plurality of results including executable software code, wherein the plurality of results is generated further utilizing a data profiler, a prompt manager utilizing the data indicating one or more descriptions associated with the domain, and an executor configured to execute the executable software code, output a plurality of results associated with the executable software code, wherein the plurality of results includes one or more confidence scores associated with the plurality of results, and in response to a selection-input, save the one or more results in the database.

A third embodiment discloses a method utilizing a machine learning (ML) model that includes the steps of receiving data indicating a query associated with a task representative of a domain, wherein the task includes generated executable software code associated with the domain, receiving data indicating one or more descriptions associated with the domain, receiving one or more exemplars associated with the data indicating the query response to an exemplar search engine running a search utilizing the data indicating the query, utilizing both the one or more exemplars and the data indicating one or more descriptions associated with the domain at a large language model (LLM) to generate a plurality of results including executable software code, wherein the plurality of results including the executable software code is generated further utilizing a data profiler, a prompt manager utilizing the data indicating one or more descriptions associated with the domain, and an executor configured to execute the executable software code, outputting a plurality of results including the executable software code, wherein the plurality of results includes one or more confidence scores associated with the plurality of results, and in response to a selection-input, saving the one or more results in the database.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 illustrates a high-level overview of an illustrative embodiment of a framework.

FIG. 4 illustrates an embodiment of a prompt structure of the system message and an embodiment of a full prompt.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The embodiment disclosed below is an LLM-powered autonomous agent that may enable domain experts or data scientist (or others) to conduct domain-specific data operation tasks with minimal human effort. Given a query and some descriptions of domain knowledge from a domain expert, the illustrative embodiment may first augment the domain knowledge description by generating multiple version of the knowledge in a step-by-step pseudo-code format. Next, the system may conduct data analysis following an iterative workflow: (1) request the LLM to write Python code; (2) execute the code; (3) request code modification if the code is not executable; (4) request the LLM to generate with insights based on execution results. The workflow may have a tree shape, where multiple data analysis reports can be generated based on multiple versions of domain knowledge description.

In one embodiment, the system may be an LLM-powered human-in-the-loop agent for data scientist and domain experts to conduct domain-specific data analysis. A LLM-powered autonomous agent may be capable of making plans and using tools, such as calling APIs and executing programming code. The system architecture may include three modules, which each can be seen as a sub-agent: (1) exemplar search engine; (2) domain knowledge enhancer and (3) auto-iterative tabular data analysis agent.

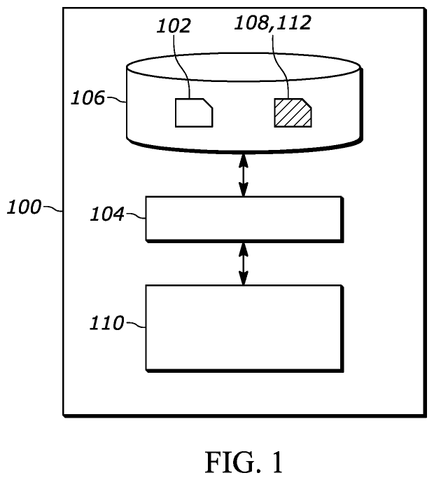

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

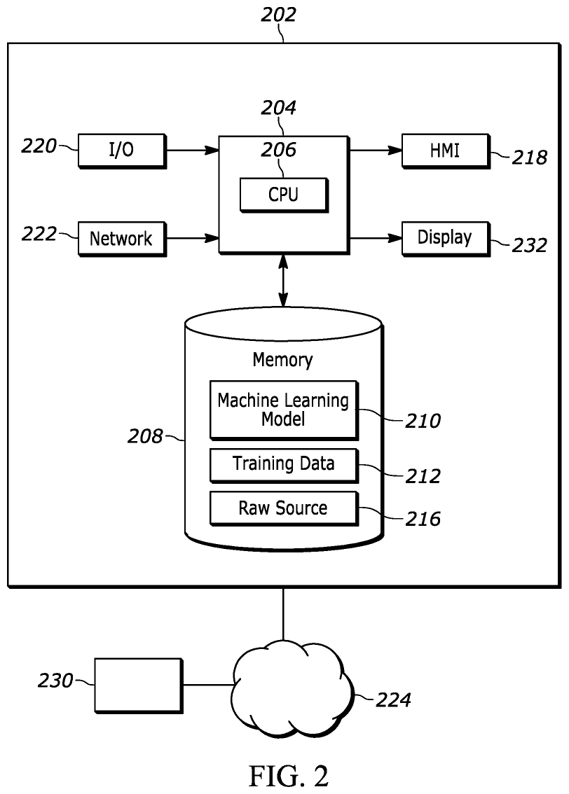

The structure of the system 100 is one example of a system that may be utilized to train the machine-learning model described herein. Additional structure for operating and training the machine-learning models is shown in FIG. 2.

FIG. 2 depicts a system 200 to implement the machine-learning models described herein. The system 200 can be implemented to predict diverse future geometries with a diffusion model, as described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

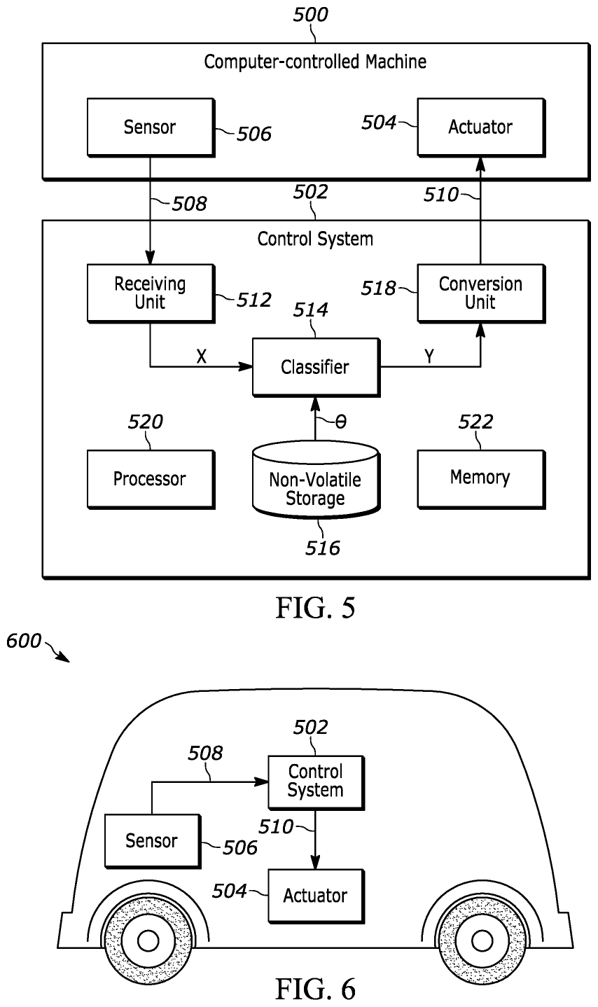

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time or time-stamped video data), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the models described herein.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera. The raw source data 216 may include a query input from a user or an automated source, such as a document.

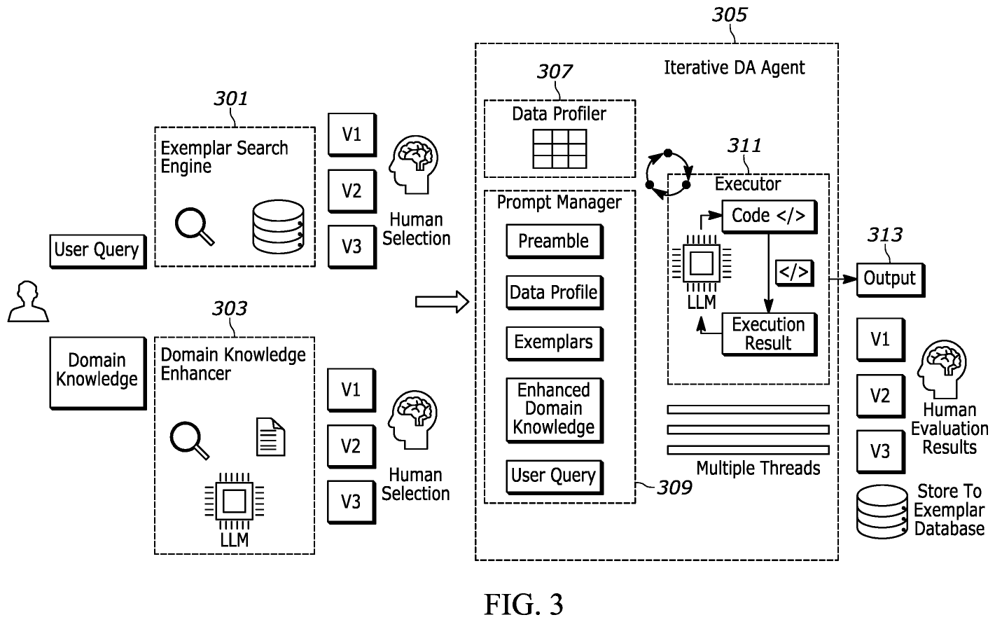

FIG. 3 illustrates a high-level overview of an illustrative embodiment of a framework. The system may include a search engine 301 or an exemplar search engine 301. Given a pool of potential exemplars and a target task, the system may compute textual similarity scores between each exemplar and the target task. Specifically, the system may encode the text of questions and reasoning chains using a pretrained transformer model. The system may then calculate the cosine similarity between the encoder outputs of the exemplars and target task. This may provide similarity scores representing how relevant each exemplar is to the downstream task. The system may select the top-k highest scoring exemplars according to this similarity metric to use as the few-shot examples in our prompt.

The system 300 may also include a domain knowledge enhances 303. Given a question ore request to conduct domain-specific data analysis, LLMS may need additional knowledge in the certain domain, such as a definition of terminology explanation of data operations, or concrete instructions. Human domain experts can easily provide such additional information. However, human experts may have little experience with LLMS and lack knowledge of prompt engineering techniques such as Chain of Thoughts (CoT). Similar to Automatic CoT and Plan-and-solve, the present embodiment may first dynamically enhance domain knowledge provided by human experts and formatted it to step by step guide. The enhancement may be based on domain knowledge input from the user (via the user query), or it can come from retrieval of documents, such as a user manual (in one example). The domain experts may modify the variations and then select one of them for the next step.

The system may utilize an original domain knowledge as well. Scalability Indicator is a measurement that looks at the ration between number of factories to number of shops. A higher Scalability Indicator means a manufacturer has more ability to expand the market.

One example may include an enhanced version. The “Scalability Indicator” may be calculated by a metric that is derived from taking the ration of the total number of production facilities (factories) to the total number of retail outlets (shops). It may serve as a measure of a manufacturing entity's ability to expand its market reach. A higher “Scalability Indicator” may imply that the manufacturer has a larger production capacity in relation to its retail footprint. This can be interpreted as the manufacturer having the potential to increase its retail outlets and expand its market without being limited by production capacity. For example, the system may calculate the total number of unique tracks (Track_ID) in ‘df’1 (which may represent the total number of “factories”). In step (2), the system may calculate the total number of unique races (Race_ID) in ‘df0’ (This may represent the total number of “shops”). In step (3), the system may compute the “Scalability Indicator” by dividing the total number of unique tracks by the total number of unique races.

The DomainDA may be built based on a framework, such as the ReAct framework, that the agent may iterate through generating reasoning traces and taking actions, following steps of “Thought: . . . Action: . . . Observation: . . . ”. The sub-agent 305 may have various modules. Some of the modules may include a data profiler 307, a prompt manager 309, and an executor 311.

The data profiler 307 may be utilized to provide context information about a dataset. This may help avoid or mitigate hallucinations. A data summary may greatly reduce the error rate for data visualization tasks. The system may extract tabular data properties, such as the number of rows and columns, data types (e.g., integer, string, Boolean), general statistics (min, max, unique values), and several random rows.

The prompt manager 309 may organize the prompts, such as goal setting, ReAct framework instruction, searched exemplars, domain knowledge and questions. The initial prompt may have three main sections: (1) Preamble, which is utilized to describe the background and the task's goal. (2) Data Profile, which is detailed description of tables. (3) Exemplars; (4) Domain knowledge and question.

An exemplar may refer to a specific instance or example within a dataset that is used to represent a particular class or category. Exemplars play a crucial role in various machine learning tasks, particularly in supervised learning where models are trained to recognize patterns or make predictions based on labeled data. For example, in a classification problem where the goal is to classify images of animals into different categories such as “cat”, “dog”, or “bird”, each image of a cat, dog, or bird would be considered an exemplar. These exemplars serve as the basis for the model to learn the distinguishing features or patterns associated with each class. Exemplars may also be used in unsupervised learning, where the task is to identify patterns or clusters in data without labeled examples. In this context, exemplars can represent individual data points or centroids of clusters, helping to summarize and understand the underlying structure of the data. Overall, exemplars are fundamental elements in machine learning algorithms as they provide the basis for learning and generalization from data. The executor may also refer to a component responsible for executing inference tasks, where the model generates text based on input prompts. Executors in this context would handle the computational workload of processing input data through the language model and producing the corresponding output.

The executor 311 may be an execution pipeline that employs the ReAct framework that the LLM is prompted to generate reasoning traces and actions, environment observations are returned to the LLM to generate the next response. In the system and method, the action may be Python code execution in one embodiment, and the observation is the execution output of the error. The executor 311 may execute tasks as a part of the job. While the ReAct framework is one example of an embodiment of a framework that can be utilized, other frameworks may be used.

The system and method in one embodiment may have two types of modes. One mode may include an interactive mode. In the interactive mode, human users may be involved in at least one of the following activities of selection of exemplars, enhancement of domain knowledge, and evaluation of the results, thereby allowing for human expertise to contribute to the data analysis process. The other mode may include an automatic mode. During the automatic mode, the language model-powered agent may autonomously perform the workflows. Thus, no human interaction may be needed.

In one example, Emma may be a line manager and a data scientist. She may responsible for monitoring the production line. She may notice that the final assembly line's production decreased recently, and she may want to check the cycle times of the particular stations.

Emma may first gather some time-series data that may be utilized in the analysis. After importing the data to the web app, she may input via typing in data context, such as “each part has a unique part id, it goes through the production line . . . ” and specific information about the data she imported. For example, the specific information may that that “This file records the location and timestamp of each part when it was processed through stations on a manufacturing line.” Such information may be used in the data profiler within the framework. There may be a user interface associated with the system and method. Emma may type the in the question “Plot a bar chart of cycle times.” She may have thought that adding an indicator of a target time would be helpful to identify stations that took longer time than expected. Thus, she may add “Display a bar chart of cycle times with a red horizontal line at 9.2 as target time. Mark the stations over target time as red.” The system may start to search relevant analysis that have been done by other analysts. However, the system may not find a relevant analysis so the default exemplar will be used. The system may always have two manually crafted exemplars. If the system found relevant exemplars, users can review the question, code, execution results, insights, and others' comments. The users can select exemplars to be used in the task. Upon the exemplars being selected, the system may search for internal documents about questions the user (e.g. Emma) asked. It may only query some basic definition of cycle time—“Cyle Time in manufacturing means the interval between a part reaching one station and the next station.” Recognizing the necessity for a more comprehensive elucidation of this concept, the user (e.g. Emma) may opt to augment the information in the text area:

“Give the location results, you should follow these steps:
1. Aggregate stations and get all the timestamps of parts on each station.
2. Calculate the intervals of each timestamp pair as cycle time, do it for all the stations;
3. Double-check if all the cycle times are larger than zero; if not, the calculation is wrong;
4. Remove the outliers of cycle times using criteria such as two standard deviation away from median.
5. Return a list of cycle time objects, each object include the station id, cycle time in seconds, timestamp, and party type.””

The user (e.g. Emma) may be able to select “Enhance domain knowledge” input from the user interface and receive three enhanced version. The user (e.g. Emma) may quickly review all the version and conclude that the first one is a suitable fit. Emma may insert additional elements such as a plot title name and click “confirm edits and run analysis” input.

The user may be able to wait before the results are displayed. On the dashboard, there may be observed distinct result tabs. Each tab may contain comprehensive information including task status (e.g., Successful, Suspended, Failed), LLM self-evaluated score (ranging from 0 to 1), visualizations (if applicable), code, and insights.

The user may carefully examine each result. Overall, they may find that the first one most aligned with their expectations, notably because the chart reflected their anticipated outcome and the code appeared accurate. The user may evaluate the results as satisfactory (or not) across three key dimensions and subsequently save them into the database.

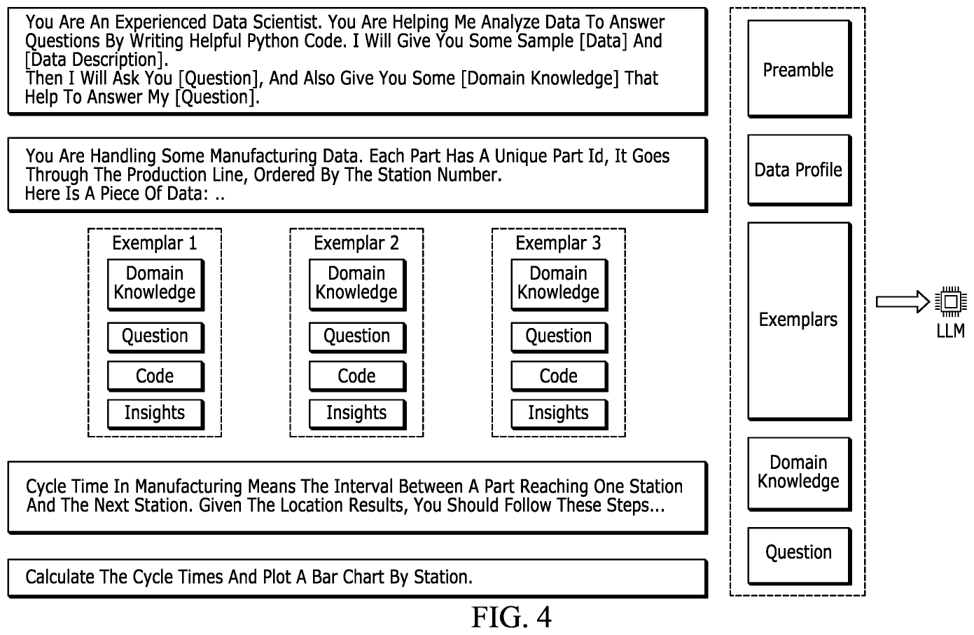

FIG. 4 illustrates an embodiment of a prompt structure of a system message. FIG. 4 may include an example of one full prompt. As shown in FIG. 4, there may be a plurality of various exemplars 403a, 403b, 403c that are utilized by the exemplar search engine. Each of the exemplars may include domain knowledge, a question, associated code, and various insights. The system may include prompts 401 to guide a user. The preamble, data profile, exemplars, and domain knowledge, and question may be fed to the LLM to generate the prompt. searched exemplars, domain knowledge and questions. The initial prompt may have three main sections: (1) Preamble, which is utilized to describe the background and the task's goal. (2) Data Profile, which is detailed description of tables. (3) Exemplars; (4) Domain knowledge and question.

In one embodiment, the generated outputs may be stored as new exemplars for future reuse, thereby continuously enriching the pool of exemplars. Those future exemplars may be stored in a database. The framework may include multiple workflows that are executable by the language model-powered agent. The workflows may be selectively performed in a variety of modes. In an interactive mode, a human user or users may be involved in at least a selection of exemplars, enhancement of domain knowledge, and evaluation of results. This may allow for human expertise to contribute to the data analysis process. In an automatic mode, the language model-powered agent may autonomously perform the workflows. A web application that may be required in the interactive mode where a user can review, select, and evaluate results generated by the framework. The data profile may succinctly summarize meta information pertaining to the task context and data. Alongside a prompt manager that collates information for LLM prompting, and an iterative code execution pipeline, such a configured would constitute the utilization of the proposed invention.

The machine-learning models described herein can be used in many different applications, and not just in the context of road sign image processing. Additional applications where anomaly detection or classification may be used are shown in FIGS. 6-11. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals and generate code to do the same based on an embodiment of the disclosure.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

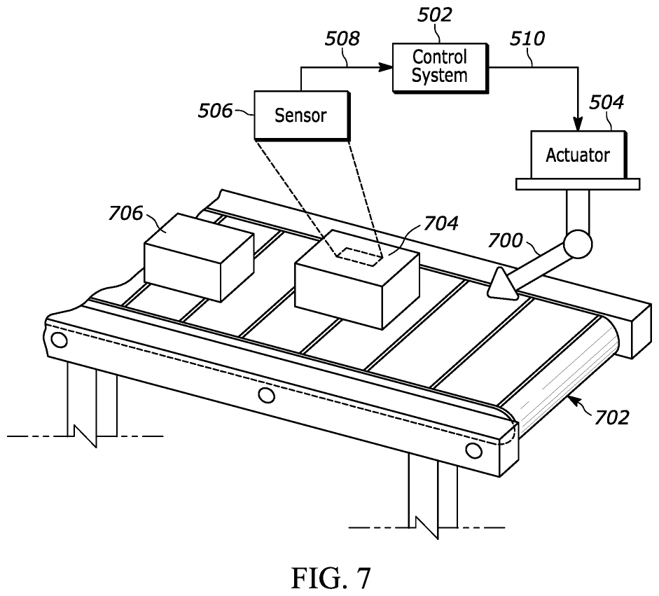

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

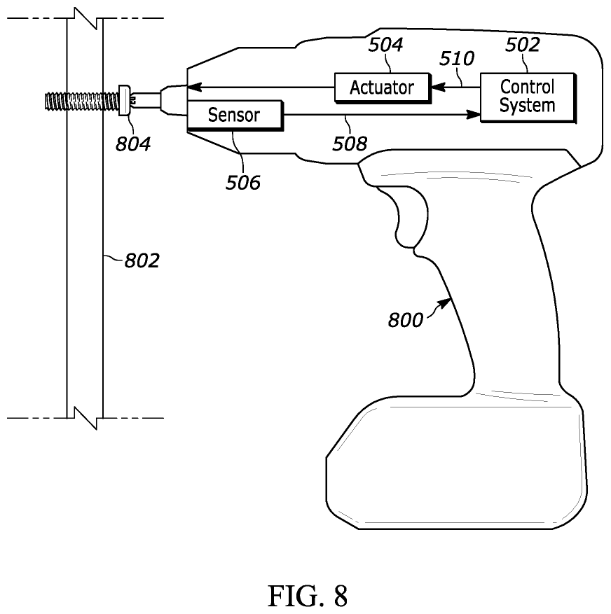

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

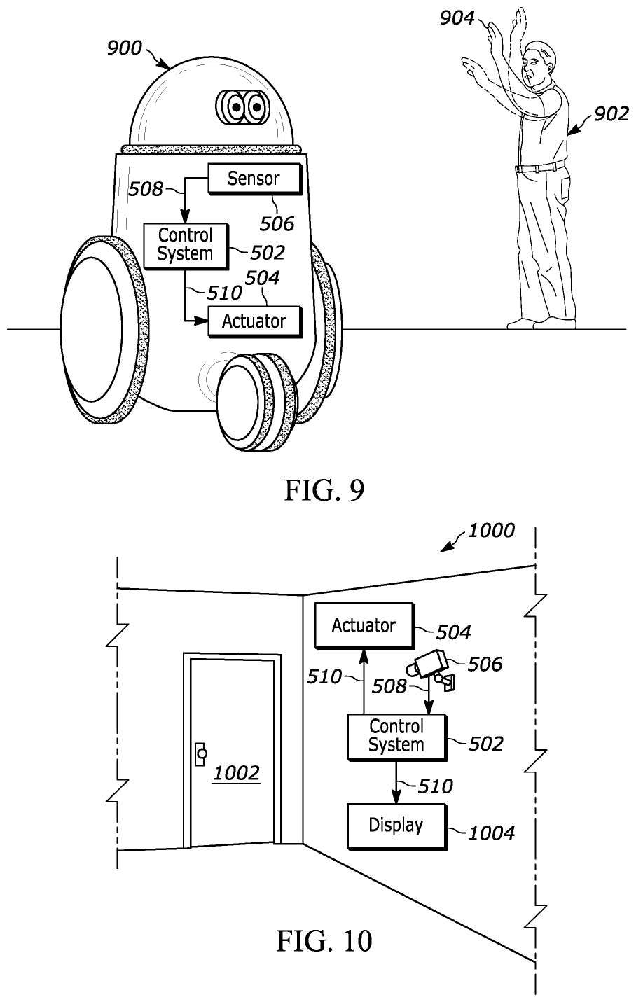

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times based on some code that is generated with the aid of a domain expert.

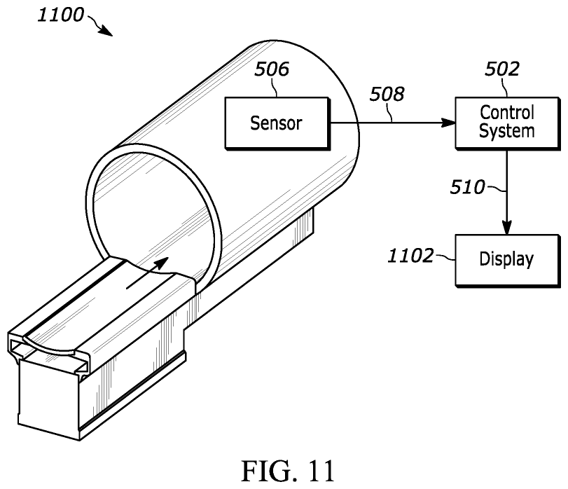

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image based on software code generated with the aid of a documentation from a domain expert or a domain expert. In this case, actuator control command 510 may be determined or selected to cause display 1102 to display the imaging and generate code from an LLM.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A method of generating data for machine learning (ML) models, the method comprising:
receiving a data indicating a query associated with a task representative of a domain, wherein the task includes generated executable software code;
receiving data indicating one or more descriptions associated with the domain;
receiving one or more exemplars associated with the data indicating the query in response to an exemplar search engine running a search utilizing the data indicating the query;
utilizing both the one or more exemplars and the data indicating one or more descriptions associated with the domain at a large language model (LLM) to generate a plurality of results including executable software code, wherein the plurality of results is generated further utilizing a data profiler, a prompt manager utilizing the data indicating one or more descriptions associated with the domain, and an executor configured to execute the executable software code, wherein the data profiler is further configured to extract tabular data properties associated with the plurality of results;
outputting a plurality of results associated with the executable software code, wherein the plurality of results includes one or more confidence scores associated with the plurality of results; and
in response to a selection-input, saving the one or more results in the database.

2. The method of claim 1, wherein the method includes activating either an interactive mode or an automatic mode.

3. The method of claim 1, wherein the executable software code is written in one or more programming languages including but not limited to Python.

4. The method of claim 1, wherein receiving data indicating one or more descriptions associated with the domain is derived from either user input or a manual that includes information absent from the LLM.

5. The method of claim 1, wherein the method includes utilizing an auto-debugger on the executable software code.

6. The method of claim 1, wherein the database is configured to allow contributions from any user and to provide access to any user for use.

7. The method of claim 1, wherein the database is stored at one or more of a cloud-based service platform an internal on-premises server system, wherein the cloud-based service platform is configured to provide scalable and distributed database services.

8. The method of claim 1, wherein the prompt manager utilizes a ReAct framework.

9. A system, comprising:
a processor programmed to:
receive a data indicating a query associated with a task representative of a domain, wherein the task includes generated executable software code;
receive data indicating one or more descriptions associated with the domain;
receive one or more exemplars associated with the data indicating the query in response to an exemplar search engine running a search utilizing the data indicating the query;
utilizing both the one or more exemplars and the data indicating one or more descriptions associated with the domain at a large language model (LLM) to generate a plurality of results including executable software code, wherein the plurality of results is generated further utilizing a data profiler configured to extract tabular data properties associated with the plurality of results, a prompt manager utilizing the data indicating one or more descriptions associated with the domain, and an executor configured to execute the executable software code;
output a plurality of results associated with the executable software code, wherein the plurality of results includes one or more confidence scores associated with the plurality of results; and
in response to a selection-input, save the one or more results in the database.

10. The system of claim 9, wherein the prompt manager utilizes a ReAct framework.

11. The system of claim 9, wherein the system includes an automatic mode and an interactive mode.

12. The system of claim 11, wherein the automatic mode is configured to operate the system autonomously and without human interaction.

13. The system of claim 11, wherein the interactive mode is configured to output queries associated with selection of an exemplar or evaluation of the plurality of results.

14. The system of claim 9, wherein the plurality of results are stored in the database as future exemplars that are accessible by the exemplar search engine.

15. The system of claim 9, wherein the method includes utilizing a data profiler configured to utilizing data indicating contextual information associated with domain.

16. The system of claim 9, wherein the database is configured to allow contributions from any user and to provide access to any user for use.

17. A method utilizing a machine learning (ML) model, the method comprising:
receiving data indicating a query associated with a task representative of a domain, wherein the task includes generated executable software code associated with the domain;
receiving data indicating one or more descriptions associated with the domain;
receiving one or more exemplars associated with the data indicating the query response to an exemplar search engine running a search utilizing the data indicating the query;
utilizing both the one or more exemplars and the data indicating one or more descriptions associated with the domain at a large language model (LLM) to generate a plurality of results including executable software code, wherein the plurality of results including the executable software code is generated further utilizing a data profiler configured to extract tabular data properties associated with the plurality of results, a prompt manager utilizing the data indicating one or more descriptions associated with the domain, and an executor configured to execute the executable software code;
outputting a plurality of results including the executable software code, wherein the plurality of results includes one or more confidence scores associated with the plurality of results; and
in response to a selection-input, saving the one or more results in the database.

18. The method of claim 17, wherein the method includes receiving the data indicating one or more descriptions associated with the domain.

19. The method of claim 17, wherein the data profiler is configured to utilize tabular data indicating contextual information associated with the data indicating a query.

20. The method of claim 17, wherein the prompt manager is configured to organize a preamble, a data profile, and the one or more exemplars.
